(19) United States
(12) Patent Application Publication
(10) Pub. No.: US 2012/0221507 A1
(43) Pub. Date: Aug. 30, 2012

(54) DECLARATIVE UPDATE TO A LIVE SYSTEM

(75) Inventors: Jamie Laflen, Bellevue, WA (US); Haroon Ahmed, Bellevue, WA (US)

(73) Assignee: Microsoft Corporation, Redmond, WA (US)

(21) Appl. No.: 13/033,605

(22) Filed: Feb. 24, 2011

(51) Int. Cl. G06F 17/30

(52) U.S. Cl. 707/600; 707/E17.009

(57) ABSTRACT

A live system manager may retrieve a current state of the live system, allow a user to edit the state, and generate a set of incremental commands that modify the current state into a desired state. The set of incremental commands may be then executed to create the desired state. In some embodiments, the set of incremental commands may be executed as a transaction. The live system manager may compare the current state to a desired state to generate the incremental commands, and may perform various validation operations during operation. A user may be presented options at various points to disambiguate the user's intentions.

### BACKGROUND

Live systems refer to computer systems that operate continually. An example may be a database system that may service many users. Such databases may be made available continually and may not be easily stopped and restarted. In some databases or other computer systems, systemic changes may often be implemented only on a system restart.

Some live systems may permit incremental commands to perform configuration changes. In an example of a database system, an incremental command may be used to add or remove a column to a table.

### SUMMARY

A live system manager may retrieve a current state of the live system, allow a user to edit the state, and generate a set of incremental commands that modify the current state into a desired state. The set of incremental commands may be then executed to create the desired state. In some embodiments, the set of incremental commands may be executed as a transaction. The live system manager may compare the current state to a desired state to generate the incremental commands, and may perform various validation operations during operation. A user may be presented options at various points to disambiguate the user's intentions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with a live system manager.

FIG. 2 is a flowchart of an embodiment showing a method for managing a live system.

FIG. 3 is a diagram illustration of an embodiment showing an example user interface.

### DETAILED DESCRIPTION

A live system manager may allow a user to update a live system by editing a declarative definition of the live system. The current state of the live system may be presented in a user interface, and a user may be able to edit the declarative definition. The live system manager may generate a series of incremental commands from the user's desired system state, then cause the incremental commands to be executed.

The user interface of the live system manager may include a text editor through which an administrator or programmer may change the definition of the live system. Once the user has finalized the definition, the live system manager may compare the desired state to the current state to identify the changes to the current state. For each of the changes or group of changes, the live system manager may create an incremental command that implements the change.

The user interface may have several features that helps the user edit the declarative definition of the live system. In some embodiments, a current system state may be updated periodically. The updated objects in the live system may be replaced, highlighted, or otherwise indicated on the user interface. Some embodiments may also identify ambiguous changes and solicit input from the user to select one of several different implementations of a change In some embodiments, a user may select a specific type of command to implement where the change may be ambiguous.

The live system may be any type of executing system, such as a database or other computer application, that may allow changes to be implemented while the system is operating. Many such systems may accept incremental commands to change the system as the system executes. Incremental commands may be commands that implement a specific change, such as adding a column to a database table or renaming an object.

In contrast with incremental commands, a declarative definition may define a live system in terms of its components. In a live database example, a declarative definition may include definitions for each table, each column of each table, and relationships between various objects in the database. In some embodiments, a user may use a declarative definition of the live system when the system is initially started. Once the system is executing, some live systems may recognize incremental commands as the mechanism to change some of the underlying components of the system.

Incremental commands operate by making a change from a current state. Often, a user may not recognize the impact of a single incremental command because the state of the system may not be fully appreciated when the incremental command is executed.

The live database system may assist the user may presenting the entire state of the system for the user to edit. Because the user is cognizant of the entire state of the system, the user may edit the system state into a desired state without having to calculate the specific incremental commands that may be used to achieve the desired state. Further, the live database system may update the current state periodically or prior to implementing the desired state. The updates may be due to instances where other users may update the current state or where pending commands to update the state are being implemented over time.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

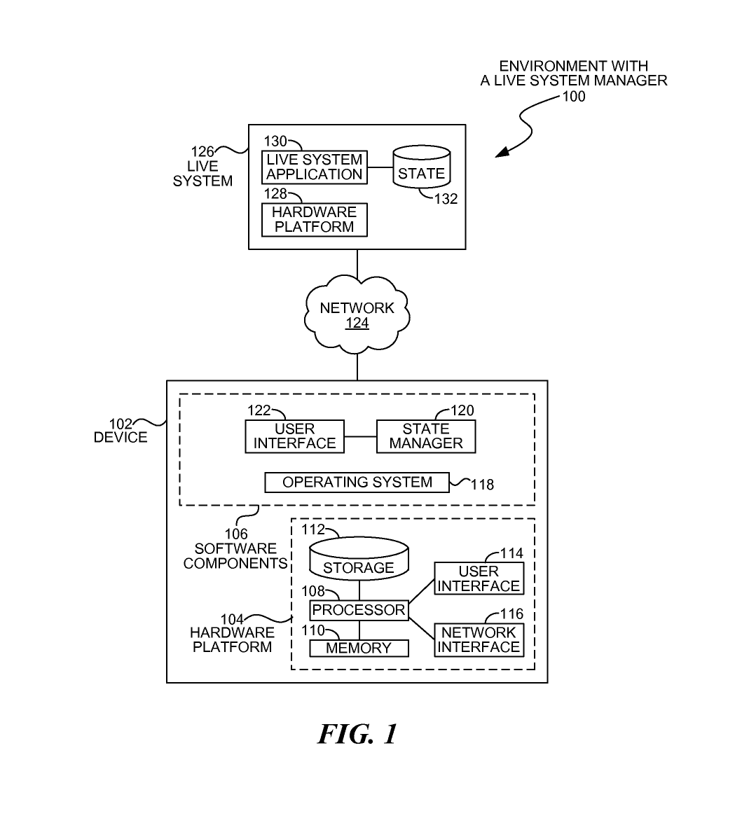

FIG. 1 is a diagram of an embodiment 100, showing an environment in which a live system manager may operate. Embodiment 100 is a simplified example of a network environment that may include a live system as well as a device on which a live system manager may execute.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a simplified environment with a live system manager. The live system manager may retrieve a current state of the live system, present the current state to a user for editing, then determine and implement a set of incremental commands that cause the live system to change state to a desired state.

The live system manager may use a declarative definition of the system state for the user to edit. The declarative definition may allow the user to view the system state in its entirety, which helps the user make changes in a more cognizant manner than purely writing and executing incremental commands. The user merely defines a desired state and the live system manager may determine a set of incremental commands that cause the desired state to be created.

The live system manager may have a text editor or other mechanism to view and interact with the current state. In many embodiments, the text editor may be populated with the current state, and a user may begin to make changes to the current state with the editor. The text editor may have various editing tools, such as object trees, navigation aids, consistency checkers, and other features that may help the user create a desired state.

The declarative definitions of the system state may be presented in a programming language or other specialized language through which the system may be defined. The specific language and language features may vary with different embodiments.

The live system may be any type of computer system that may be executing when changes are made to the system. In the case of a live database, the database may respond to read and write commands on an ongoing basis while operating as a live application. The state of such as system, from the standpoint of the live system manager, may be the schema, table definitions, relationships, or other definitions that define the structure of the database system.

Throughout this specification and claims, the state of a live system may define the structural components on which the live system may execute. The state of the live system may remain constant while the live system executes until one or more incremental commands are executed, where the incremental commands cause the system state to change.

In the case of a live system that executes a database, the state may include the database schema. In the case of other live systems, the state may include schema, interfaces, structural components, or other definitions.

The system state, as used in the specification and claims, may not include data that may be processed by the system. Many live systems may receive, process, store, transmit, or otherwise manage data objects. Such operations and data objects are considered outside the “system state” as defined in this specification and the claims.

Embodiment 100 illustrates and architecture where a client device may access a live system remotely. Using the client device, a user may change the system state with a locally running set of applications. In a typical use scenario, the user may establish an authenticated session with a live system, create a set of incremental commands, and transmit the commands to the live system.

In such an embodiment, the live system may be an application that may be executing on a remote server, cloud computing platform, or otherwise operate as a remote service.

In other embodiments, the components of the live system manager may execute on the same hardware platform as the live system.

The device 102 may have a set of hardware components 104 and software components 106. The client device 102 may represent any type of device that may communicate with a live system 126.

The hardware components 104 may represent a typical architecture of a computing device, such as a desktop or server computer. In some embodiments, the client device 102 may be a personal computer, game console, network appliance, interactive kiosk, or other device. The client device 102 may also be a portable device, such as a laptop computer, netbook computer, personal digital assistant, mobile telephone, or other mobile device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include one or more user interface devices 114 and network interfaces 116. The user interface devices 114 may include monitors, displays, keyboards, pointing devices, and any other type of user interface device. The network interfaces 116 may include hardwired and wireless interfaces through which the device 102 may communicate with other devices.

The software components 106 may include an operating system 118 on which various applications may execute.

The software components 106 may include a state manager 120 and a user interface 122 that may make up a live system manager. The state manager 120 may perform various operations to retrieve and update the state of the live system 126, while the user interface 122 may present and capture changes to the current state.

The software architecture of embodiment 100 is merely one example of an architecture that may make up a live system manager. Other embodiments may have additional or fewer components and may have different divisions of tasks, perform operations in different manners, or have other configurations than that of embodiment 100.

The state manager 120 may retrieve the current state from the live system 126 and prepare the current state for presentation. In many embodiments, the state manager 120 may gather the current state and generate a declarative definition of the current state for presentation in the user interface 122. In some embodiments, the live system 126 may transmit a declarative definition of the state in response to a query from the state manager 120. In other embodiments, the state manager 120 may perform a query or set of queries from which the state manager may generate a declarative definition.

The state manager 120 may also receive the desired state from the user interface 122 and generate a set of incremental commands that may be transmitted to the live system 126. The state manager 120 may perform various checks, such as verifying consistency, disambiguating user intent, and other functions.

In some embodiments, the state manager 120 may cause the set of incremental commands to be executed as a transaction. In such an embodiment, the entire set of incremental commands may be executed as an atomic operation. Should one of the commands fail, the entire transaction may be aborted.

The state manager 120 may periodically update the current state by querying the live system 126 while a user may be defining a desired state. The state manager 120 may perform a query, identify changes to the live system 126 since the last query, and cause any updated elements to be highlighted or updated on the user interface 122.

The user interface 122 may present the current state of the live system 126 for the user to edit or otherwise manipulate. In many embodiments, the user interface may include a text editor, which may present the current state of the live system 126 as a starting point for editing. The user may start with the current state of the live system 126 and then edit the declarative definition to generate a desired state of the live system 126.

As the user edits the current state, the user interface 122 may have various components to assist the user. For example, some user interfaces may include a hierarchical navigation aid that may present a hierarchical view of objects within the declarative definition. The user may be able to interact with the objects in the hierarchical navigation aid to rearrange the objects, view or change the object properties, or perform other operations.

In some embodiments, the user interface 122 may allow a user to select an object and perform an operation on the object. For example, a user may highlight or select an object, such as a table in a database, and right-click to cause a menu of available operations to be presented. The user may select from the menu to perform an operation.

In one example, a user may highlight an object to bring up a menu that may allow the user to rename or replace the object. The user may select one of the available options and the user interface may cause the selection to be performed.

In some embodiments, the user may perform an edit and a disambiguation operation may be performed. For example, a user may edit an object name. The disambiguation operation may determine that the edited object name may have two implementations: renaming the object or replacing the object. In the case of a database system, replacing the object may cause any data stored in the object to be deleted, while the renaming operation may be propagated to other locations within the declarative definition.

The device 102 may be connected to a network 124 to the live system 126. The network 124 may be any type of communications network, such as a wired or wireless network. In some embodiments, the network 124 may be a local area network, wide area network, the Internet, or other type of network.

The live system 126 may be any type of executing application that may accept incremental commands that may change the system state while the application is executing. The live system 126 may execute on a hardware platform 128, which may be a server computer, cloud computing platform, or other type of hardware platform. In most cases, the hardware platform 128 may be similar to the hardware components 104 and may contain a processor with various memory and peripheral devices.

The live system application 130 may be any type of application that may accept system state changes while executing. Conventional, non-live applications may operate by changing system state only at startup, while live applications may permit state changes using incremental commands while the application is executing. Live applications may be capable of continuous operation while system state changes are being implemented.

The live system application 130 may have a state definition 132. In some embodiments, the state definition 132 may be a configuration file or other separately stored definition. In other embodiments, the state definition 132 may be stored internally to the live system application 130 and may be retrieved through a query to the live system application 130.

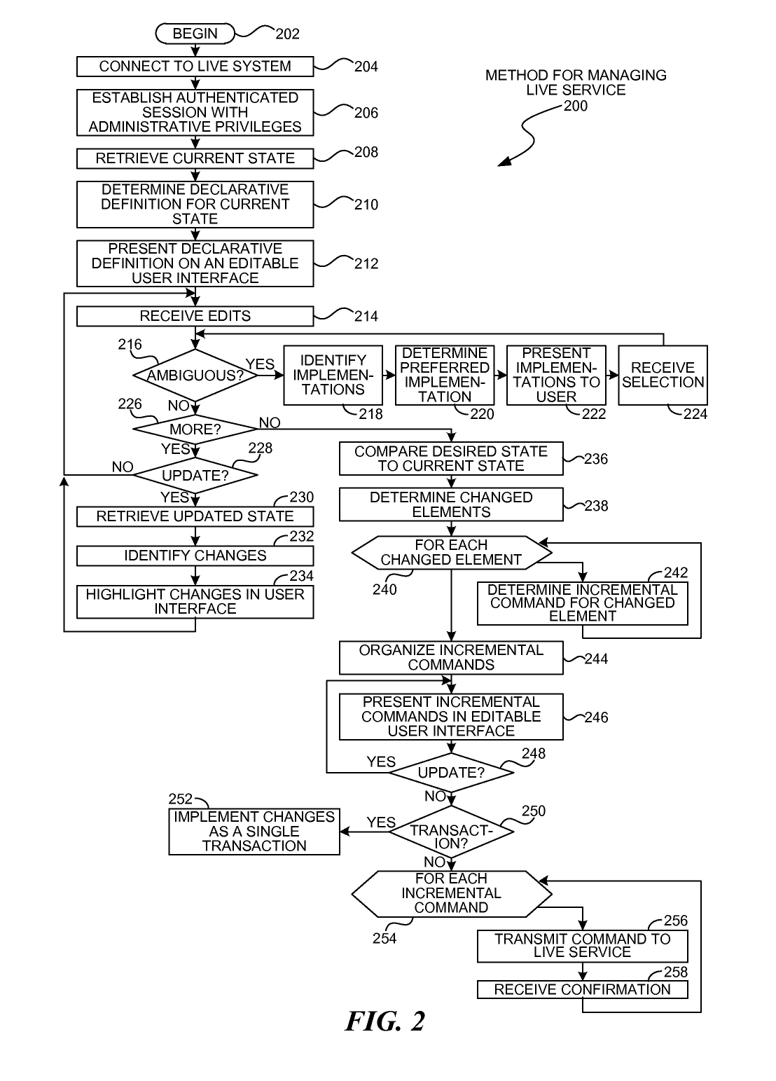

FIG. 2 is a flowchart illustration of an embodiment 200 showing a method for managing a live service. Embodiment 200 is a simplified example of a method that may be performed by a state manger and user interface, such as the state manager 120 and user interface 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process may begin in block 202.

In block 204, a connection may be established with the live system. In block 206, an authenticated connection may be established with administrative credentials. When system state is being changed on the live system, many embodiments may permit such changes only when the user has administrative privileges. Such credentialing may permit system changes only for certain users and not others.

The current state of the live system may be retrieved in block 208. In some embodiments, a state manager may transmit a query to the live system, which may return the current state. In other embodiments, the state manager may read a configuration file or obtain the system state in another manner.

A declarative definition of the system state may be determined in block 210. In some embodiments, the declarative definition may be retrieved directly from the live system. In other embodiments, a declarative definition may be generated after gathering various data about the live system.

The declarative definition may be presented to the user in block 212 for editing. In many embodiments, a text editor may be used to present the current state and receive edits in block 214. The edits may define a desired version of the live system.

If an edit is ambiguous in block 216, the various implementations of the edit may be identified in block 218. In some embodiments, a preferred implementation may be determined in block 220.

A preferred implementation may be determined from a policy or set of policies. The policies may define which implementations are preferred over others. In some cases, a preferred implementation may be the default and other implementations may be implemented only when a user overrides the default.

For example, a live database system may have a policy that does not permit a state change that results in data loss without overrides. In one such example, a user may change the name of a database table. One implementation may be to merely rename the table without data loss, while another implementation may be to delete the current table and replace the table with a new table having a different name. In such a situation, the policy may prefer the renaming implementation because the renaming operation may be performed without data loss in the database.

In block 222, the implementation options may be presented to the user and the user's selection may be received in block 224. The process may then return to block 216.

If there are more edits in block 226, the process may return to block 214.

In some embodiments, the current state of the live system may be updated in block 216. In such a case, the updated state may be retrieved from the live system in block 230. Changes between the original current state and the updated state may be identified in block 232 and highlighted in the user interface in block 234. The process may return to block 214 for more edits.

When the editing has completed in block 226, the user may have defined a desired state for the live system. The desired state may declaratively define the entire state of the live system.

The desired state may be compared to the current state of the live system in block 236. The changed elements between the current and desired states may be identified in block 238.

For each changed element in block 240, an incremental command may be generated in block 242. The incremental commands may be organized in block 244 into a sequence for implementation. In some cases, different sequences of commands may result in different states of the live system.

In some embodiments, the incremental commands may be presented to a user in block 246. The user may be able to review or edit the incremental commands and may be able to update the incremental commands in block 248, where the process may return to block 246. Once the user is satisfied with the set of incremental commands in block 248, the incremental commands may be sent to the live system for implementation.

In some embodiments, the changes to a live system may be performed as a transaction. Some embodiments may permit a user to determine if the commands are implemented as a transaction or may have a default setting or set of policies that determines whether or not to perform a transaction.

If a transaction is to be performed in block 250, the set of incremental commands may be implemented as a transaction in block 252. A transaction may be a set of incremental commands that are executed as an atomic command where the entire set of commands may be committed only when each and every command has successfully completed. If a single command fails from the set of incremental commands, the entire transaction may be aborted.

If the set of incremental commands are not to be implemented as a transaction in block 250, each command may be performed in series. For each incremental command in block 254, the command may be transmitted to the live service in block 256, confirmation may be received in block 258, and the process may return to block 254 to process another command.

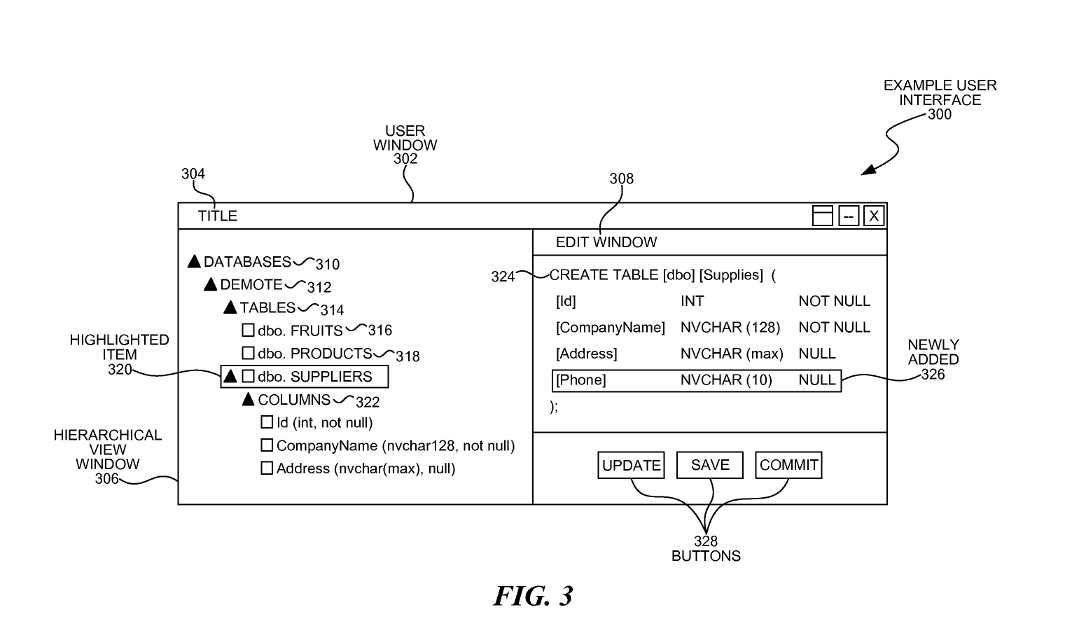

FIG. 3 is a diagram illustration of an embodiment 300 showing an example user interface. Embodiment 300 is a simplified user interface that shows an example system that may have two different mechanisms to browse a live system state, and a declarative mechanism for editing the state.

The user window 302 may be an administrative interface through which a developer may browse and edit the current state of a live system. The user window 302 may have a title 304, a hierarchical view window 306, and an edit window 308.

The hierarchical view window 306 may show the components of the live system through various components. The hierarchical view window 306 may have interactive components where a user may expand and collapse various objects to browse the objects.

The edit window 308 may have a declarative description of some or all of the objects depicted in the hierarchical view window 308. In the edit window 308, a user may be able to add, delete, or modify portions of the description of the live system, then have those modifications implemented or committed to the live system.

In the example of the hierarchical view window 308, the database object 310 is illustrated as expanded, showing the database “demodb” object 312, which is also expanded. Within the “demodb” database, the tables object 314 is illustrated as expanded, showing tables dbo.FRUITS 316, dbo.PRODUCTS 318 and dbo.SUPPLIERS 320.

The dbo.SUPPLIERS 320 object is expanded, showing columns 322, which also is expanded. In the example, the columns 322 include “Id”, “CompanyName”, and “Address”.

The hierarchical view window 308 may be used to browse the objects defined for the live system. In the example of embodiment 300, the live system may be the database “demodb”. The user may be able to highlight or select a portion of the objects for modification. In the example of embodiment 300, the dbo.SUPPLIERS 320 object is illustrated as highlighted.

The highlighted or selected objects from the hierarchical view window 308 may be presented in the edit window 308 for editing. The content 324 of the edit window may be a declarative definition of the highlighted objects from the hierarchical view window 308.

The content 324 may minor the dbo.SUPPLIERS 320 object from the hierarchical view window 308. The content 324 is illustrated as having an additional column “Phone” that is presented as newly added 326. The definition of “Phone” may be added by the user by merely typing the declarative definition of the column

After completing any edits, the user may activate one of the buttons 328 to update the changes to the hierarchical view, save the changes for later implementation, or commit the changes to the live system. When the changes are committed to the live system, the changes may be converted into incremental commands that may be issued to the live system.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A live system manager comprising:
a connection to a live database;
a state manager that:
retrieves a current state from said live database, said current state defining a current database structure;
a user interface that:
presents said current state to a user;
receives a desired state from said user, said desired state being an edited version of said current state;
said state manager that further:
determines a set of incremental commands that define changes from said current state to said desired state; and
executes said set of incremental commands.

2. The live system manager of claim 1, said state manager that further:
identifies a set of changed elements between said current state and said desired state from which said set of incremental commands are determined

3. The live system manager of claim 2, said state manager that further:
determines a second current state after said current state is presented to a user;
identifies a second set of changed elements between said current state and said second current state; and
highlights at least one of said changed elements in said second set of changed elements on said user interface.

4. The live system manager of claim 1, said user interface comprising a text editor in which said current state is presented to said user.

5. The live system manager of claim 1, said state manager that further:
identifies an ambiguous change, said ambiguous change having at least two different implementations; and
receives a selection from said user to select one of said at least two different implementations.

6. The live system manager of claim 5, said at least two different implementations comprising renaming an object and replacing an object.

7. The live system manager of claim 6, said state manager that further:
receives said selection being said renaming; and
propagates a renamed object through said desired state.

8. The live system manager of claim 5, said state manager that further:
presents said at least two different implementations to a user prior to said receives said selection.

9. The live system manager of claim 1, said state manager that executes said set of incremental commands as a transaction.

10. The live system manager of claim 1, said user interface that further:
presents said set of incremental commands to said user prior to said executes said set of incremental commands.

11. The live system manager of claim 10, said user interface that further:
receives edits to said set of incremental commands from said user.

12. A method performed on a computer processor, said method comprising:
connecting a live system;
retrieving a current state from said live system;
determining a declarative definition for said current state;
presenting said declarative definition on a user interface;
receiving an updated state from said user interface;
comparing said current state to said updated state and determining a set of incremental commands that cause said live system to change from said current state to said updated state; and
causing said live system to execute said incremental commands to change said live system to said updated state.

13. The method of claim 12, said user interface being an editable user interface and said updated state being an edited version of said current state.

14. The method of claim 13 further comprising:
identifying an ambiguous change to said current state, said ambiguous change having at least two implementations.

15. The method of claim 14 further comprising:
presenting said at least two implementations to said user; and
receiving a selected implementation from said user.

16. The method of claim 14 further comprising:
retrieving a policy definition;
using said policy definition to select a preferred implementation from said at least two implementations.

17. The method of claim 16 further comprising:
presenting said at least two implementations on said user interface with said preferred implementation as a highlighted implementation; and
receiving a selected implementation from said user.

18. A computer readable storage medium comprising computer executable instructions, said computer executable instructions comprising a method, said method comprising:
establishing an authenticated session with a live service, said live service being changeable only with incremental commands;
retrieving a current state from said live service;
determining a first declarative definition for said live service, said first declarative definition representing said current state;
presenting said first declarative definition to a user in an editable user interface;
receiving edits from said user, said edits defining a second declarative definition for said live service;
comparing said first declarative definition and said second declarative definition to identify a group of changes;
determining a set of incremental commands defining said group of changes; and
causing said live service to execute said set of incremental commands.

19. The method of claim 18 further comprising:
presenting a hierarchical view of objects within said first declarative definition.

20. The method of claim 19 further comprising:
retrieving a second current state after said presenting said first declarative definition to a user in an editable user interface;
comparing said current state and said second current state to identify a second group of changes; and
indicating said second group of changes on said editable user interface.
